(19) United States
(12) Patent Application Publication
(10) Pub. No.: US 2004/0204154 A1
(43) Pub. Date: Oct. 14, 2004

(54) Wireless transmitter-receiver set for mobile phone

(76) Inventor: Li-Jung Chang, Taipei (TW)

Correspondence Address: Connolly Bove Lodge & Hutz LLP, P.O. Box 2207, Wilmington, DE, 19899-2207, US

(21) Appl. No.: 10/087,168

(22) Filed: Mar. 1, 2002

(51) Int. Cl. H04M 1/00

(52) U.S. Cl. 455/569.1; 455/557

(57) ABSTRACT

A wireless transmitter-receiver set for a mobile phone comprises a base unit and a remote unit. The base unit has a voice receiver and a transmitter circuit. Sound from a speaker of a mobile phone handset is received by the voice receiver, amplified and emitted as a radio-frequency signal. The remote unit receives the emitted radio-frequency signal, which is subsequently demodulated, amplified and passed on to a remote speaker to be audible. The voice uttered by the user can be transmitted to a destination via a microphone in the mobile phone of the user.

### BACKGROUND OF THE INVENTION

1. Field of the Invention

The present invention relates to a wireless transmitter-receiver set for a mobile phone.

2. Description of Related Art

With progress in technology, communication demands are readily satisfied by mobile phones, which have become popular and convenient tools for sharing messages at any time and any place.

However, in certain environments, using a mobile phone is inconvenient or even dangerous, e.g., while carrying objects with both hands or while driving. Under these circumstances, a mobile phone cannot be held in the hand. For this reason, hands free for mobile phones of various types have been developed and are widely used, eliminating the need to hold the phone in the hand. This is an improvement, but another problem arises. Since many types of mobile phones are available on the market, each having a proprietary set of connectors and interface standard, hands free on the market are suitable for certain types of mobile phones, and there is no way to adapt to all available mobile phones. This is a shortcoming of conventional hands free.

Furthermore, conventional hands free have connecting cables, which is inconvenient.

A conventional hands free, which is supposed to allow to telephone without using hands, is in practice mainly used during driving, being in most cases placed close to the driver's seat and connected by tangled cables, so that a driver is distracted and driving safety is impaired.

### SUMMARY OF THE INVENTION

It is the main object of the present invention to provide a wireless hnads free for a mobile phone which is suitable for all types of mobile phones and eliminates the need to hold the mobile phone, requiring only to fix the mobile phone thereon, without interface problems, and being able to be placed at any suitable location, with no need of power cables and connecting cables and without the inconvenience of a headset.

### BRIEF DESCRIPTION OF THE DRAWINGS

The present invention can be more fully understood by reference to the following description and accompanying drawings, in which:

FIG. 1 is a front view of the base unit of the present invention in conjunction with a mobile phone handset;

FIG. 2 is a front view of the base unit of the present invention separated from the mobile phone handset;

FIG. 3 is a block diagram of the transmitter circuit of the present invention;

FIG. 4 is a block diagram of the receiver circuit of the present invention;

FIG. 5 is a front view of the remote unit of the present invention;

FIG. 6 is a side view of the base unit of the present invention, demonstrating adaptability thereof to various mobile phone handsets.

FIG. 7 is a circuit diagram of a transmitter of the present invention; and

FIG. 8 is a circuit diagram of a receiver of the present invention.

### DETAILED DESCRIPTION OF THE PREFERRED EMBODIMENT

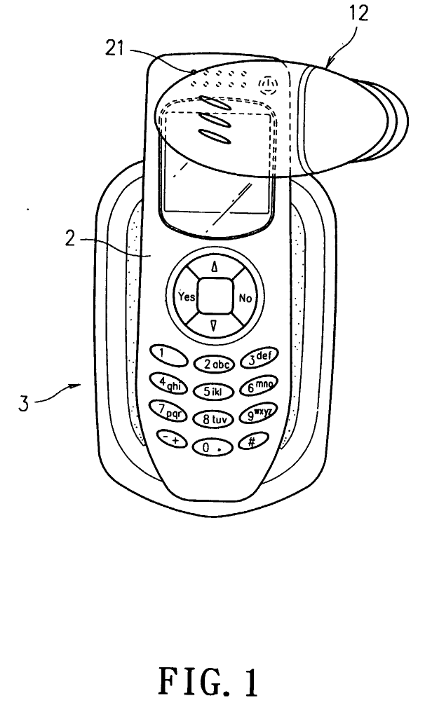

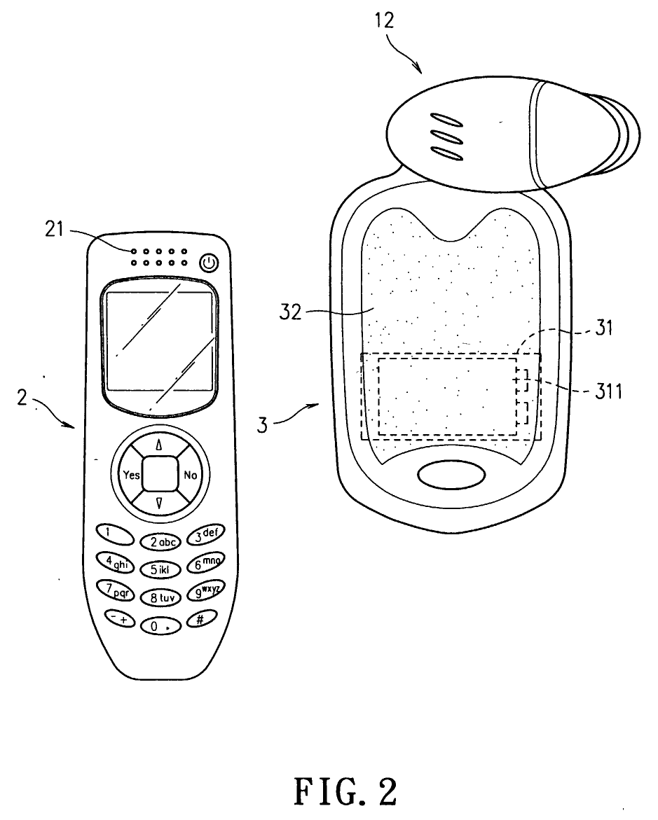

The wireless transmitter-receiver set for a mobile phone of the present invention is used in conjunction with a mobile phone handset 2, enabling a user to use the mobile phone handset 2 with the hands off. As shown in FIGS. 1 to 6, the wireless transmitter-receiver set for a mobile phone of the present invention mainly comprises a base unit 3 and a remote unit 4. The base unit 3 has an extension piece 1, to which a voice receiver 12 is attached. As shown in FIGS. 1, 2 and 6 again, the extension piece 1 provides a length thereof being adjustable. The voice receiver 12 can be a microphone or the like and is oriented at a flexible angle to be adaptable to any type of mobile phone handsets.

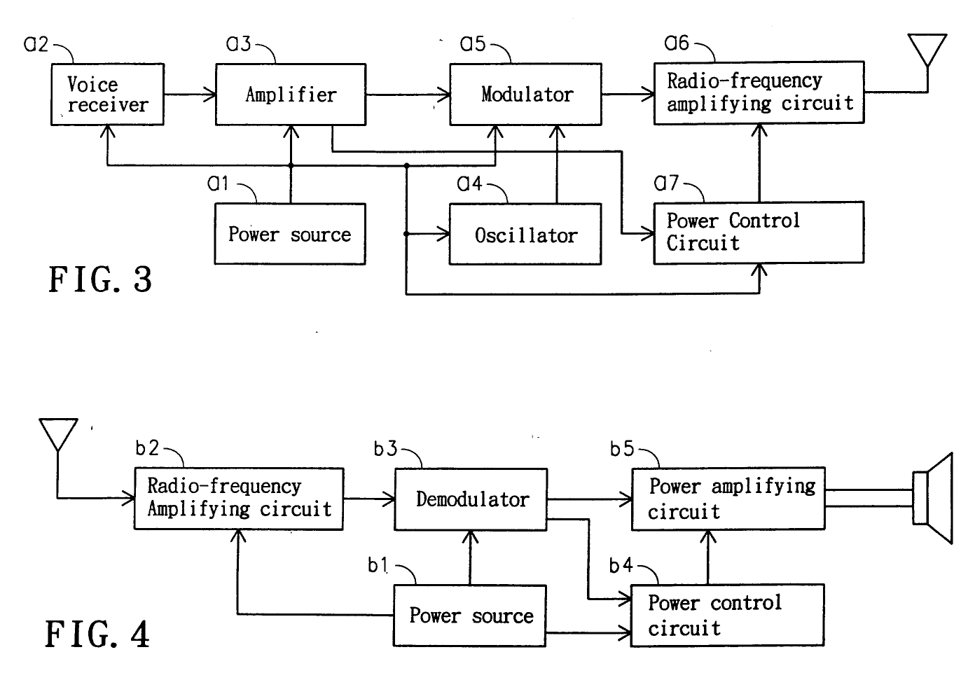

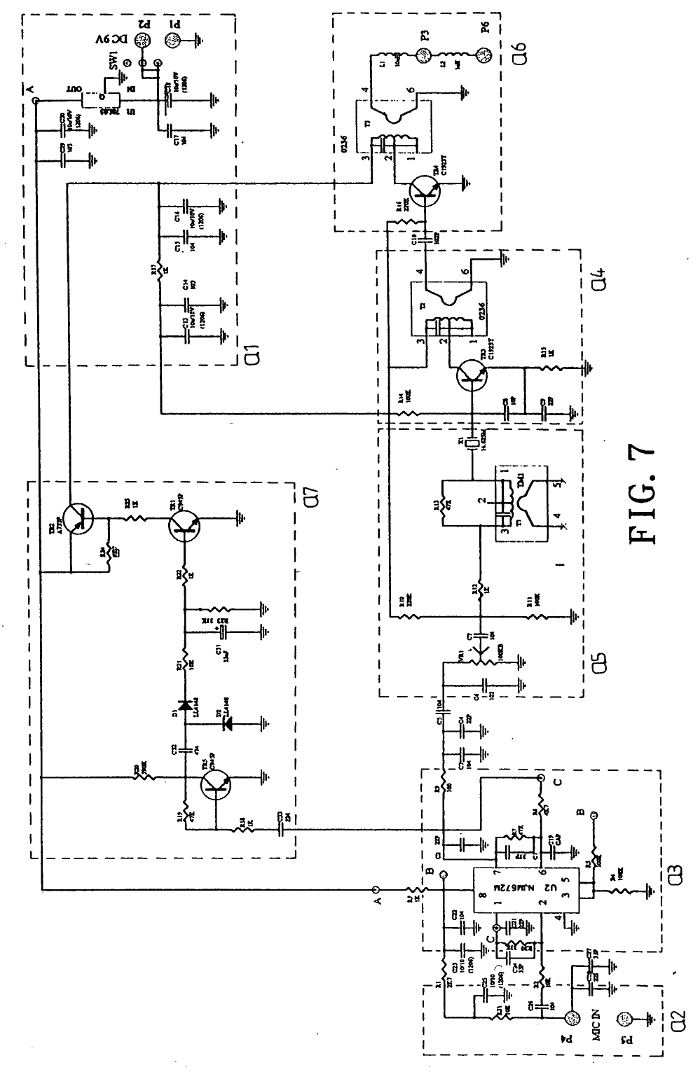

The base unit 3 has an accommodating space 32 to accommodate any type of mobile phone handsets and houses a transmitter circuit and a battery chamber 31. A battery 311 is placed inside the battery chamber 31. The transmitter circuit has the following components, as indicated in FIGS. 3 and 7:

a1. Power source: a battery 311 is used for powering the transmitter circuit.

a2. Voice receiver: a voice receiving component is disposed next to a speaker 21 of the mobile phone so as to receive a voice signal from the speaker 21 and to transmit the voice signal for being amplified.

a3. Amplifier: the voice signal is amplified and transmitted for being modulated and power controlled.

a4. Oscillator: an oscillating signal is generated and transmitted.

a5. Modulator: the voice signal from the amplifier and the oscillating signal from the oscillator are modulated as radio-frequency signal.

a6. Radio-frequency amplifier: the radio-frequency signal is amplified and emitted out via an antenna.

A7. Power controller: the amplified voice signal is treated under control such that the radio-frequency amplifier is supplied with power during the mobile phone being connected and is not supplied with power during the mobile phone being alert or not in use.

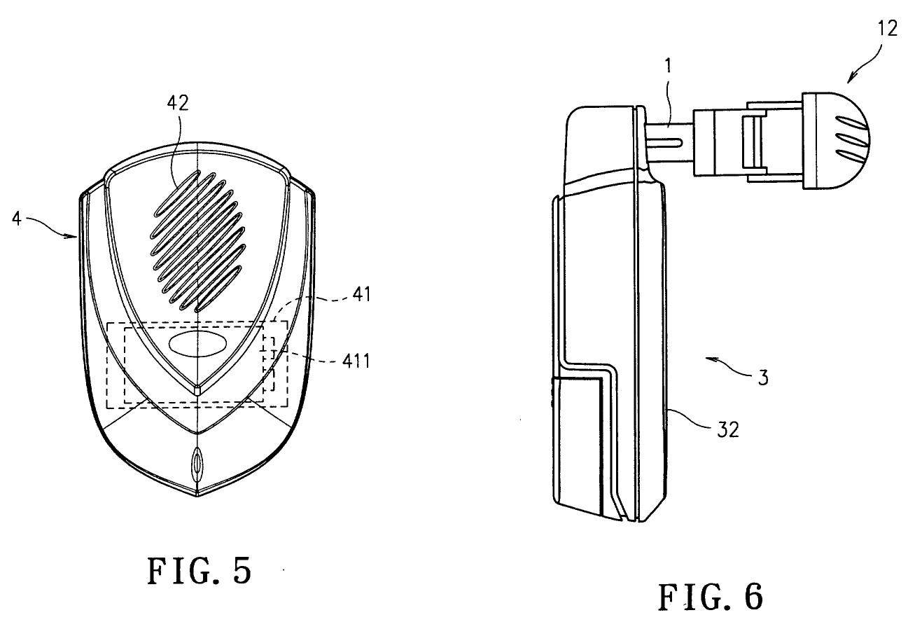

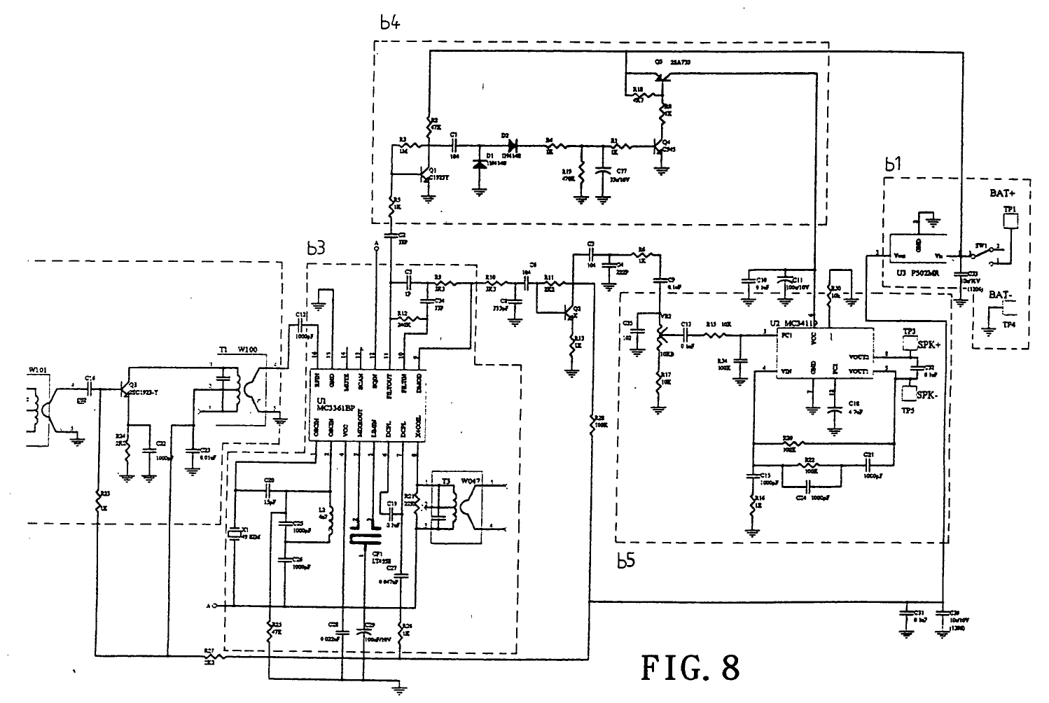

Referring to FIG. 5 again, the remote unit 4 has a battery chamber 41, a remote speaker 42, and a wireless receiver circuit. The battery chamber 41 contains a battery 411. Referring to FIGS. 4 and 8 again, the receiver circuit has the following components based on the theory:

b1. Power source: the battery 411 is used for powering the receiver circuit.

b2. Radio-frequency amplifying circuit: the radio-frequency signal from the transmitter is amplified and emitted via an antenna for being demodulated.

b3. Demodulator: the amplified radio-frequency signal is demodulated as audio signal and intermediate frequency signal and transmitted to be power amplified and to be power controlled.

b4. Power control circuit: the demodulated intermediate frequency signal is amplified and power controlled such that the power can be supplied to a power amplifying circuit while the mobile phone is connected and is switched off power amplifying circuit while the mobile phone is in a state of standing by or not using.

b5. Power amplifying circuit: the power amplifying circuit is a amplifier circuit for amplifying the demodulated signal and driving a remote speaker.

The present invention allows the user to use the mobile phone handset 2 without holding the mobile phone handset 2 next to the ear. Sound from the speaker 21 of the mobile phone handset 2 is received by the voice receiver 12 on the extension piece 1 and amplified and emitted as a radio-frequency signal by the base unit 3.

The remote unit 4 receives the emitted radio-frequency signal, which is subsequently demodulated, amplified and passed on to the remote speaker 42 to be audible. The voice uttered by the user is received with a microphone of the mobile phone handset 2.

While the invention has been described with reference to a preferred embodiment thereof, it is to be understood that modifications or variations may be easily made without departing from the spirit of this invention which is defined by the appended claims.

What is claimed is:

1. A wireless transmitter-receiver set for a mobile phone, comprising:
abase unit, having an extension piece with a voice receiver and an accommodating space, furthermore housing a transmitter circuit and a battery chamber into which a first battery is inserted; and
a remote unit, having a receiver circuit, a remote speaker and a battery chamber into which a second battery is inserted.

2. A wireless transmitter-receiver set for a mobile phone according to claim 1, wherein said transmitter circuit of said base unit further comprises:
a power source, powering said transmitter circuit and being powered by said first battery;
a voice receiver, receiving a voice signal from a speaker of a mobile phone handset and transmitting said voice signal to be amplified and power controlled;
an amplifier, amplifying said voice signal and transmitting said voice signal to be modulated;
an oscillator, generating an oscillating signal and transmitting said oscillating signal;
a modulator, modulating said voice signal with said oscillating signal, generating a modulated voice signal;
a first radio-frequency amplifying circuit, amplifying said modulated voice signal and emitting said modulated voice signal via an antenna; and
a power controller: the amplified voice signal being treated under control such that the radio-frequency amplifier being supplied with power during the mobile phone being connected and being not supplied with power during the mobile phone being alert or not in use.

3. A wireless transmitter-receiver set for a mobile phone according to claim 1, wherein said receiver circuit of said remote unit further comprises:
a power source, powering said receiver circuit, powered by said second battery;
a second radio-frequency amplifying circuit, receiving a radio signal from said transmitter circuit by an antenna, amplifying said radio signal and transmitting said radio signal to be demodulated;
a demodulator, demodulating said radio signal, generating a demodulated signal and an intermediate-frequency and transmitting said demodulated signal to be amplified and power controlled;
a power amplifying circuit, amplifying said demodulated signal and driving said remote speaker; and
a power control circuit, receiving said demodulated intermediate-frequency signal and controlling said power source;
whereby, said power amplifying amplifier can be supplied with power while said mobile phone is connected and switched off power while said mobile phone is in a state of standing by or not in use.

4. A wireless transmitter-receiver set for a mobile phone according to claim 1, wherein said extension piece of said base unit is expandable and contractible.

5. A wireless transmitter-receiver set for a mobile phone according to claim 1, wherein said voice receiver of is a microphone or the like.

6. A wireless transmitter-receiver set for a mobile phone according to claim 1, wherein said voice receiver on said extension piece is flexibly oriented at various angles to adapt to every shape of mobile phone handsets.
